(19) United States
(12) Patent Application Publication
(10) Pub. No.: US 2014/0074728 A1
(43) Pub. Date: Mar. 13, 2014

(54) SYSTEM FOR SOCIAL CARE ROUTING, PRIORITIZATION AND AGENT ASSISTANCE

(71) Applicant: Five9, Inc., San Ramon, CA (US)

(72) Inventor: Edwin Margulies, Van Alstyne, TX (US)

(73) Assignee: Five9, Inc., San Ramon, CA (US)

(21) Appl. No.: 13/793,723

(22) Filed: Mar. 11, 2013

Related U.S. Application Data
(60) Provisional application No. 61/699,119, filed on Sep. 10, 2012.

(51) Int. Cl. G06Q 30/00

(52) U.S. Cl. CPC G06Q 30/01
USPC 705/304

(57) ABSTRACT

A system for social care routing, prioritization and agent assistance for interfacing with a carrier network, a social listening device, a social network or proprietary social feedback apparatus, and a contact center and contact center database. Author postings, demographic information, sentiment, topical relevancy, and customer service requests and other data are used for prioritization, agent assistance and routing. A contact center database and a social network listening device or proprietary social feedback apparatus obtain information used in determining routing and tagging instructions. A user interface is connected to the system to accept configurable conditions for determining customer service instructions to the agents. A color-coded agent heads-up display for author and customer profiling and customer relationship management timeline is disclosed for effectively managing social posts and authors needing customer service assistance by agents at each target enterprise contact center.

### CROSS-REFERENCE TO RELATED APPLICATIONS

The present non-provisional patent application claims priority to U.S. Provisional Patent Application Ser. No. 61/699,119 filed on Sep. 10, 2012 entitled “System for Social Care Routing, Prioritization and Agent Assistance” the contents of which are incorporated herein by reference.

### STATEMENT RE: FEDERALLY SPONSORED RESEARCH/DEVELOPMENT

Not Applicable

### BACKGROUND

1. Technical Field

The present disclosure relates generally to telecommunications systems, and more particularly, to a social networking customer care system.

2. Related Art

Social networks, web-based articles and blogs facilitate the sharing of comments, photographs, and other data amongst its users. These users typically establish accounts and create profiles containing basic biographic data. The subject matter of comments posted on social networking sites oftentimes touch upon daily life experiences, including those relating to interactions with consumer-oriented businesses and products thereof. Accordingly, the observation of user-generated content on social networking sites provides companies an insight into their customers' minds, and is a valuable metric that goes beyond traditional surveying modalities.

Various systems for observing activity on social networks are known in the art, including Radian6, Lithium, Jive, Getsatisfaction.com, and so forth. Unfortunately, however, the metrics and logic required to take action and provide assistance in the form of customer service from the enterprise are difficult to manage and essential data is largely missing to process customer service items with efficiency.

Another problem that besets the enterprise in providing customer service over social media is that most customer service centers do not have the skills or know-how to mix and score internal customer data and match it with external, social data in order to properly process and disposition customer complaints and inquiries. As a result, customer service over social media is effectively operating as an island in the enterprise contact center.

Another problem that besets the agents handling customer service over social media is that traditional customer management systems do not provide a flexible heads-up display depicting topic relevance, social influence and enterprise, or customer influence all in one place. In addition, customer record systems record events as individual records, each requiring the agent to open individual records to get the gist of what is going on with a particular author or customer. Such traditional systems only provide discrete “snapshots in time” and do not provide any trending data or adjacent dialogues in a simple, easy to read, e.g., color-coded display. As a result, agents are forced to plod through dozens, or sometimes hundreds of individual records to perform a manual analysis of the customer history.

Accordingly, there is a need in the art to connect social media personas and authors with internal enterprise customer records so that normal business rules and actions can be leveraged when dealing with social media that requires customer service center assistance. Furthermore, there is a need in the art for systems that provide an appropriate heads-up display and computer screen workspace for agents to easily understand the context of social communications and mentions as it relates to their enterprise customer policies. For instance, it would be advantageous to merge social media into enterprise customer records and automatically score and update enterprise records for sentiment, influence, relevancy of content and other attributes to make service decisions easier or automated for the agent. Additionally, it would be advantageous to situate dialogues with the author or customer in a flexible timeline display, with color-coded bars and pop-up boxes to indicate sentiment, relevancy and details from other agents in a summarized fashion, instead of opening individual records manually to do manual analysis of customer history.

### BRIEF SUMMARY

The present disclosure is directed to a system for routing, prioritization and agent assistance that connects social network interactions with customer service interactions, and determining the priority of routing based on certain attributes of the author by combining data from the social network with data of the customer relationship management (CRM) system so as to create unique profiles and scoring systems to aid in dispositioning transactions for agent assistance. The routing, prioritization and agent assistance system can be between the social networks and the enterprise customer service center and provide prioritization, routing and scoring such that social media streams are more easily blended with common enterprise customer records, using common contact center apparatus.

In accordance with one embodiment, there is a communications system for bridging social networks and customer contact centers. The system may include a customer data access point connected to first data links to the social networks over carrier networks and receptive to social data and routing information requests thereof. There may also be an enterprise data access point connected to second data links to the customer contact centers. Furthermore, there may be an application server connected to the incoming data access point. The received social data and routing information requests may be segregated based at least on configurable routing instructions. The system may further include a component database. Additionally, there may be a natural language understanding (NLU) filtering engine for automated categorization and routing. Additionally there may be a rules-based engine for providing automated agent instructions. These engines may be connected to the application server and to the enterprise data access point for communicating with the customer contact centers.

According to another embodiment, there is provided a communications system for bridging social networks and customer contact centers. The system includes a customer data access point disposable in communication with a social network to receive social data therefrom. A natural language understanding (NLU) engine is in communication with the customer data access point and is configured to analyze the social data and identify actionable characteristics associated with the social data. A rules engine is in communication with the NLU engine and is configured to match the identified actionable characteristics with a prescribed set of processing rules. An application server is in communication with the customer data access port, the NLU engine, and the rules engine and is configured to execute the set of processing rules matched with the identified actionable characteristics. An enterprise data access point is in communication with the application server and disposable in communication with a customer contact center to communicate with the customer contact center for executing the processing rules.

The received social data may include a customer service request. A component database may include stored prioritization levels associated with customer service request attributes. The application server may be configured to assign a prioritization label to the customer service request in response to a query of a component database.

The communication system may additionally include an agent interface in communication with the enterprise data access point and may be configured to display customer information in accordance with a color coded scheme. The color coded scheme may include a central customer icon and at least one peripheral identifier disposed at least partially about the customer icon and associated with an attribute related to the social data author.

According to another aspect of the present invention, there is provided a method for bridging social networks and customer contact centers. The method includes receiving social data from a social network, and analyzing the social data to identify actionable characteristics associated with the social data. The method further includes comparing the identified actionable attributes with a database of operational instructions matched with stored actionable attributes to identify operational instructions associated with the identified actionable attributes. The method additionally includes executing the identified operational instructions which includes sending a communication to a customer contact center.

The method may further include the step of storing the social data received from the social network.

The analyzing step may include identifying at least one of routing, origination or tag information associated with the social data. The analyzing step may additionally include processing the social data with a natural language understanding (NLU) engine to identify the actionable characteristics. The NLU engine may categorize the identified actionable characteristics into predefined categories, the categories being associated with operational instructions. The NLU engine may analyze the social data to determine a sentiment of the author of the social data, the identified sentiment being used to determine the operational instructions.

The comparing step may include determining the routing instructions for the communication to be sent to the customer contact center. The comparing step may also includes assigning a prioritization to the operational instructions when the social data meets a prescribed prioritization threshold.

The method may additionally include the step of matching the received social data with stored customer data. The matching step may include matching the received social data with buying history data associated with the author of the social data.

The method may additionally include the step of generating a color coded display, wherein the colors depicted on the display are associated with attributes related to the social data author. The generating step may include generating a central customer icon and at least one peripheral identifier disposed at least partially about the periphery of the central customer icon, wherein the at least one peripheral identifier being associated with an attribute related to the social data author.

The method may further comprise the step of generating a color coded display associated with a customer relationship management timeline, depicting color coded correspondence between the author of the social data and the customer service center.

The method may additionally include the step of generating an agent assistance template based upon information contained in the social data.

The method may further include the step of assigning an author sentiment score associated with the social data.

The method may also include the step of assigning an author influence score associated with the social data.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram illustrating of a system for social care routing, prioritization and agent assistance constructed in accordance with one embodiment of the present disclosure;

FIG. 2 is a flowchart showing the steps of receiving, filtering, and scoring of incoming social data according to one aspect of the present disclosure;

FIG. 3 is a diagram showing a heads-up agent display of customer or author attributes in accordance with an embodiment of the present disclosure; and

FIG. 4 is a diagram showing additional agent display elements for providing agent assistance according to one embodiment.

Common reference numerals are used throughout the drawings and the detailed description to indicate the same elements.

### DETAILED DESCRIPTION

The detailed description set forth below in connection with the appended drawings is intended as a description of the presently preferred embodiment of the present disclosure, and is not intended to represent the only form in which the present invention may be developed or utilized. The description sets forth the functions of the invention in connection with the illustrated embodiment. It is to be understood, however, that the same or equivalent functions may be accomplished by different embodiments that are also intended to be encompassed within the scope of the invention. It is further understood that the use of relational terms such as first and second and the like are used solely to distinguish one from another entity without necessarily requiring or implying any actual such relationship or order between such entities.

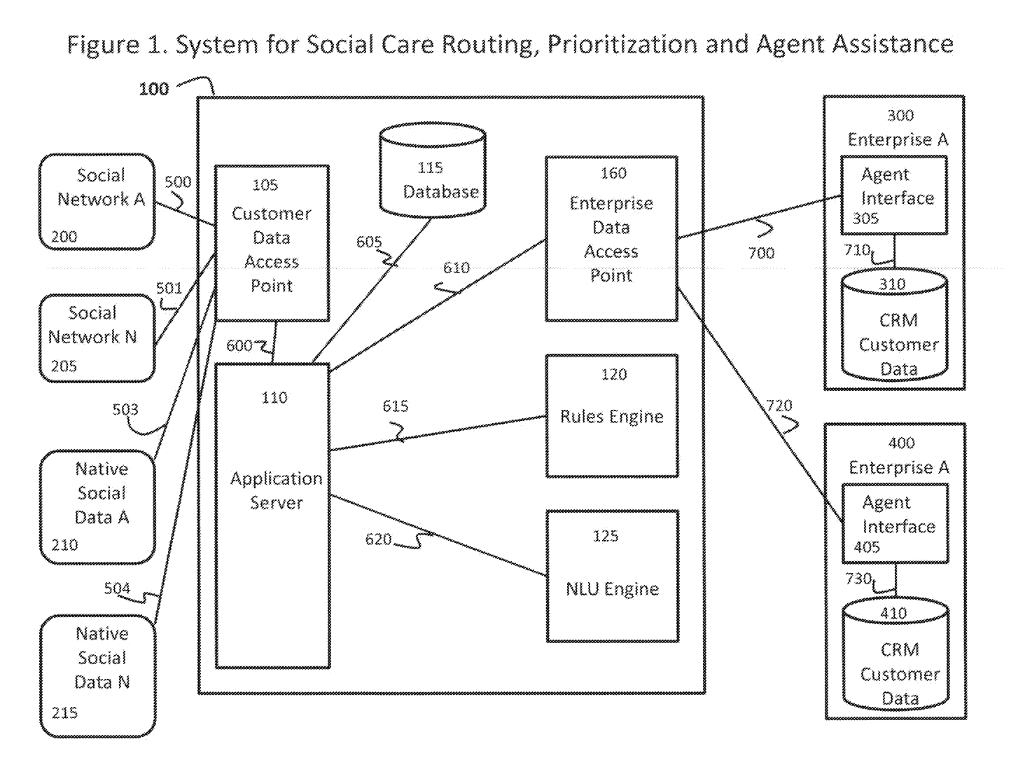

With reference to FIG. 1, a system for social care routing, prioritization and agent assistance 100 is illustrated, along with its interaction with a plurality of social networks, native social networks, and a plurality of enterprises. The system for social care routing, prioritization and agent assistance 100 includes a customer data access point 105, an application server 110, and a database 115. Furthermore, there is a rules engine 120 and a natural language understanding (NLU) engine 125. The system for social care routing, prioritization and agent assistance also includes an enterprise data access point 160. Further details regarding these components and their interconnections will be described more fully below.

The system for social care routing, prioritization and agent assistance 100, and specifically the customer data access point 105 thereof, is connected to a social network A 200 and a social network N 205 over a communications channel 500 and a communications channel 501, respectively. In one preferred embodiment of the invention, such communications channels 500, 501 may be the Internet or other Internet Protocol (IP)-based modality, and is understood to convey information over the HyperText Transfer Protocol (HTTP) or Secure Hypertext Transfer Protocol (HTTPS). In an alternate embodiment of the invention, such facilities may be proprietary in nature, bearing information conveyed over private networks.

Those having ordinary skill in the art will recognize various listening devices that produce HTTP/HTTPS streams of data that can be re-directed or listened to by a variety of devices. Such devices are typically agent consoles, in which agents are able to view social networking information that has been filtered social listening devices. These may be available from Salesforce.com and Attensity, for example.

The customer data access point 105 captures the stream of data from the social network A 200 and/or the social network N 205. It is to be understood that while the present disclosure only shows two social networks A, N 200, 205, there may be others connected to the system for social care routing, prioritization and agent assistance in accordance with different embodiments of the present disclosure. Thus, the social network N, in this context, is understood to refer to an indeterminate one.

The stream of data from the social networks A, N 200, 205 may have embedded information therein such as social influence tags, sentiment tags, net promoter score (NPS) tags, content relevancy tags, demographic tags, or other attributes that may be useful in processing social stream data for further routing or disposition. Here, the customer data access point 105 is used to parse, inject, and format social data based on information supplied by templates that are pre-defined in the database 115. The application server 110 is used to decide what templates and what subsequent actions are taken depending on the incoming social streams.

Native social data A 210 and native social data N 215 also connect to the customer data access point 105 over communications channels 503, 504, respectively. In one embodiment of the invention, such communications facilities may similarly be the Internet or any IP-based modality and will convey information over HTTP or HTTPS. In an alternate embodiment of the invention, such facilities may be proprietary in nature, bearing information conveyed over private networks. Native social data A 210 and native social data N 215 may convey social information that is embedded inside of proprietary software, such as smartphone devices, private enterprise web sites, or other proprietary devices. Such devices can be programmed to transmit social networking information, including social influence tags, sentiment tags, net promoter score (NPS) tags, content relevancy tags, demographic tags, including verbatim quotes, that can be filtered and tagged by the native social data A 210 and the native social data N 215 entities. In this scenario, the customer data access point 105 captures the stream of the native social data A 210 and the native social data N 215.

The steam of native social data A 210 and native social data N 215 may have embedded information therein such as sentiment tags, scoring tags, product tags, or other attributes that may be useful in processing social stream data for further routing or disposition. The customer data access point 105 is used to parse, inject, and format social data based on information supplied by templates that are pre-defined in the database 115. The application server 110 is used to decide what templates and what subsequent actions are taken depending on the incoming social streams.

The application server 110 is connected to the customer data access point 105 over a communication channel 600. Such channel 600 may be an IP communication channel, or a proprietary channel Likewise, the application server 110 is connected to the database 115 over another communications channel 605. This communications channel may be implemented as a Java Database Connectivity (JDBC) access method, Structured Query Language (SQL) Query, Stored Procedure Call, or a variety of proprietary methods for database communications. The database 115 may be local or remote.

The application server 110 is also connected to the rules engine 120 over a communication channel 615. The communication channel 615 can be an IP connection, HTTP, REST or other means to send signals and data. Additionally, the application server 110 is connected to the NLU engine 125 over a communication channel 620. Such a communication channel can be an IP connection, HTTP, REST or other means to send signals and data. The application server 110 is also connected to the enterprise data access point 160 over a communication channel 610. Likewise, the communication channel 610 can be an IP connection, HTTP, REST or other means to send signals and data.

The database 115 stores a variety of information dealing with social post content and author data, social attribute tag data, routing and destination data, timing threshold information, and other attributes that aid in the processing and disposition of social networking media streams. Templates are stored in the database 115 that define pre-determined routines for processing social media streams. User interfaces to the database 115 can be implemented as web pages, and those having ordinary skill in the art will recognize the various ways in which the storage of user-typed data in templates inside of a database can be achieved. The templates can be created by a provider of the system for social care routing, prioritization and agent assistance 100; or, with the proper security, can be created by users of an enterprise A 300 or of an enterprise N 400. The application server 110 can be used to govern the communications with the database 115 in the case of its access being allowed for users of the respective enterprises A and N, 300, 400.

The rules engine 120 receives incoming social media stream information and analyzes the information to match each social post with a predetermined set of rules. These rules may deal with service level thresholds for the timing of unanswered posts, the level of social/public influence of an author, and the level of customer importance of the enterprise offering the social care services. The tools for triggering decisions are known to those having ordinary skill in the art. Those practitioners will recognize the form of Boolean logic and workflow rules commonly available in open source products such as JBOSS/DROOLS for example. Assuming the business rules data in a stored template in the database 115 calls for a social stream to be tagged as a service escalation target, the rules engine will tag the item and insert an agent-specific next best action text instruction in the template. This template will be used subsequently to populate an agent screen display in order to assist the agent in the disposition or resolution of a social item. In a preferred embodiment of the invention, the social author attributes may be matched with customer records in order to provide next best action instructions to the agent in a form consistent with the native customer relationship management (CRM) system.

Likewise, if a response back to the poster is required, the rules engine 120 may be used to govern the tagging and storage of replies in a CRM timeline display, and tag replies with attributes for hiding or exposing the response data depending on the class of service of the agent or supervisor. For example, agents outside of a specific workgroup may not be able to see CRM timeline data, whereas a workgroup supervisor or fellow workgroup agent will be able to see the data. It will be appreciated that the rules engine 120 can be used to govern the behavior or a variety of agent-facing displays, such that only items befitting the skills of a certain agent will be displayed. Likewise, the rules engine 120 can be used to toggle display filters and orders based on time of day, priority, or other customer-specific attributes such as customer value.

The NLU engine 125 uses algorithms operating on word and phrase matching to automatically categorize social posts into like issues. According to one embodiment, tools such as those from open source Apache OpenNLP, Stanford NLP, and LingPipe can be utilized. The NLU engine 125 may be capable of reading text and ascertain sentiment of the author, and relevancy of the post based on pre-formed criteria.

In an alternate embodiment, the routing and destination data included in a stored template in the database 115 may call for a social stream to be rated for content relevancy and sentiment of the author. Here, the NLU engine 125 will parse the data, create a sentiment, and relevancy score, and embed all of the requisite scoring information into the item. In a preferred embodiment of the invention, the authors' posts may be related in such a way as to provide the agent with scoring data to forecast the likelihood of the post being “spam.” Likewise, data tagged with sentiment by the NLU engine 125 may be used to prioritize the routing and disposition of a social item.

The enterprise data access point 160 derives its chief communications payload, media and routing information from the application server 110. The application server 110 can use the template data stored in the database 115 to instruct the enterprise data access point 160 how to assemble coordinating routing and destination data, along with any appropriate tag or attribute data, such that it can assemble information in the appropriate target CRM system or proprietary agent heads-up display for any given enterprise.

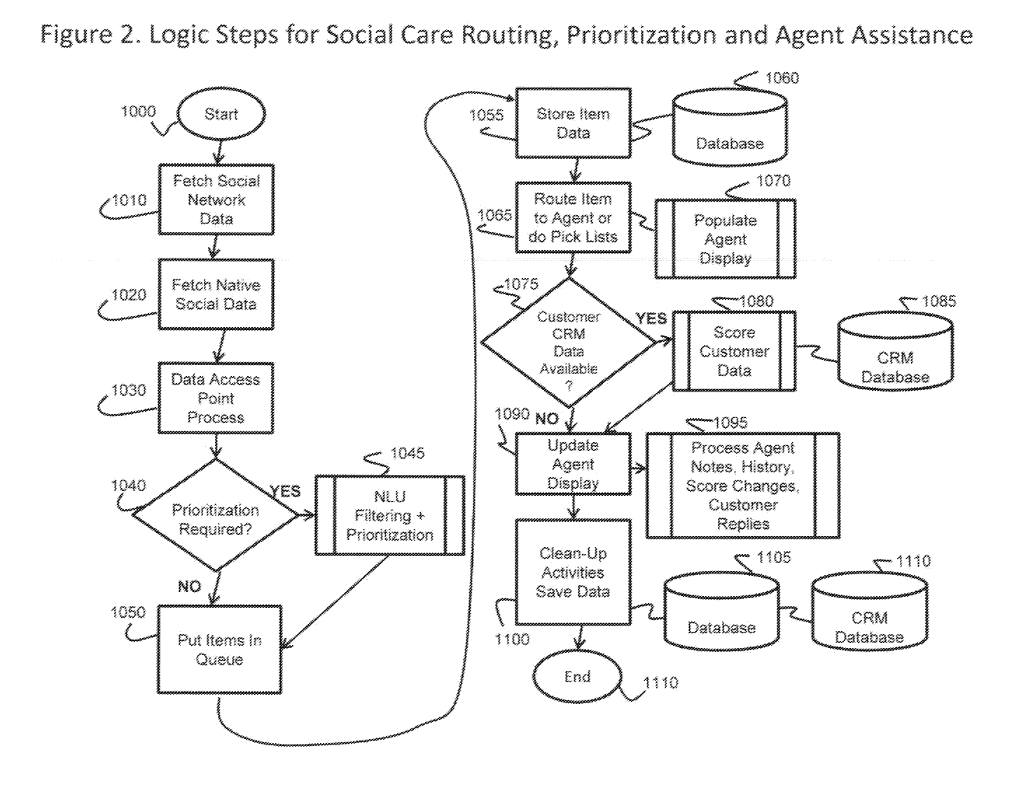

One embodiment of the present disclosure contemplates a method that includes the receipt, labeling, and storing of incoming social data, as illustrated in the flowchart of FIG. 2. The method has a start 1000 and is understood that social mentions are created on a formal social network, blog site, enterprise customer service portal, or on a proprietary smartphone or other proprietary application in the form of a private or native sentiment broadcast or mention. Next, at step 1010, the system for social care routing, prioritization and agent assistance 100 fetches such social network data. This data may be raw, unfiltered data, or it may be pre-processed by a listening device, such as those available from Attensity or Salesforce.com. Likewise, such social data may be pre-processed by a rules engine, or natural language understanding (NLU) engine. Next, in step 1020, native social data, including proprietary or standard sentiment broadcast data is fetched.

The system for social care routing, prioritization and agent assistance 100 then utilizes the data access point 105 to parse the text of the social data in order to identify any routing, origination, or tag information, or other intelligent attributes that may be used in its disposition per step 1030. Thereafter, the system for social care routing, prioritization and agent assistance 100 determines if a prioritization request is required for the type of social media fetched in a decision branch 1040. This data is stored in a template in the database 115 wherein data updated by the rules engine 120 and the NLU engine 125 resides. If prioritization is required, the method proceeds to step 1045 where rules and NLU data are used based on available data in the stored templates. If no priority routing is required, the process proceeds to step 1050 where the appropriate routing labels and other data are tagged to the social media stream for routing to agents downstream.

At step 1055, the system for social care routing, prioritization and agent assistance 100 stores the social media data in the database 115 per step 1060. Such data may be used as an archive or for purposes of store-and-forward for redundancy and recovery. Per step 1065, the system for social care routing, prioritization and agent assistance 100 further determines if ACD-like (automatic call distributor like) routing or pick listing is required in making the items available for agent review. Depending on the routing rules stored in the database, the system loads that data into the memory of the enterprise data access point 160. At step 1070, the enterprise data access point 160 sends the social item and its associated attributes to the agent interface 305,405.

At a decision branch 1075, the application server 110 queries the CRM customer data 310, 410, via the enterprise data access point 160. In a preferred embodiment of the invention, the enterprise data access point 160 will have direct access to the CRM customer data 310, 410. In an alternate embodiment, the enterprise data access point 160 will have access to the CRM Customer data 310, 410 via the agent interface 305, 405. The purpose of the query is to ascertain the availability of relevant customer data that can be matched with the social data. For example, customer value score data, recent buying history data, or trouble ticket data. Such data is then matched by the application server 110 with the rules engine 120 to determine if any pre-set rules will govern agent next best actions or agent display attributes. If no data is available, the process moves to updating the agent interface 305. 405 with available data.

At step 1080, the application server 110, in conjunction with the rules engine 120 scores all of the customer data and then stores any updates in the database 115. If the match of customer data is conclusive, in step 1090, the requisite display triggers are calculated by the application server 110 and transmitted to the enterprise data access point and finally to the agent interface 305. 405.

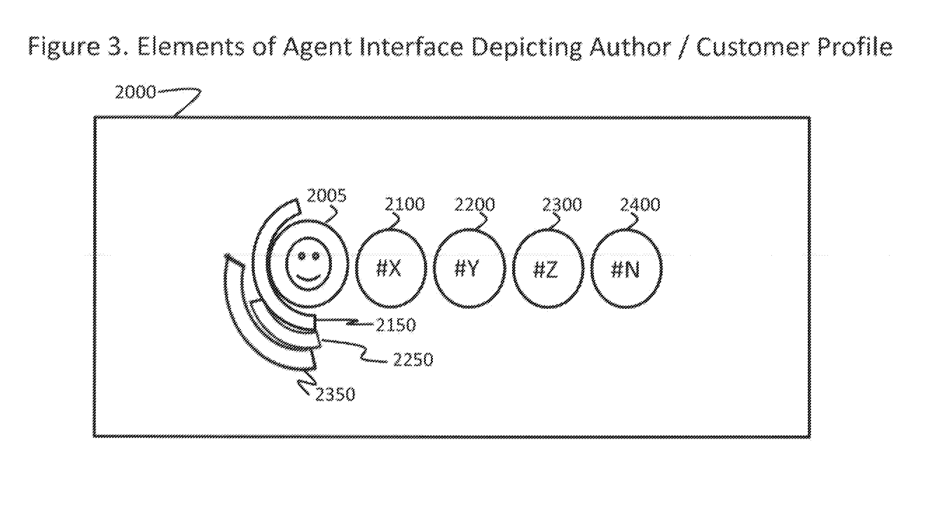

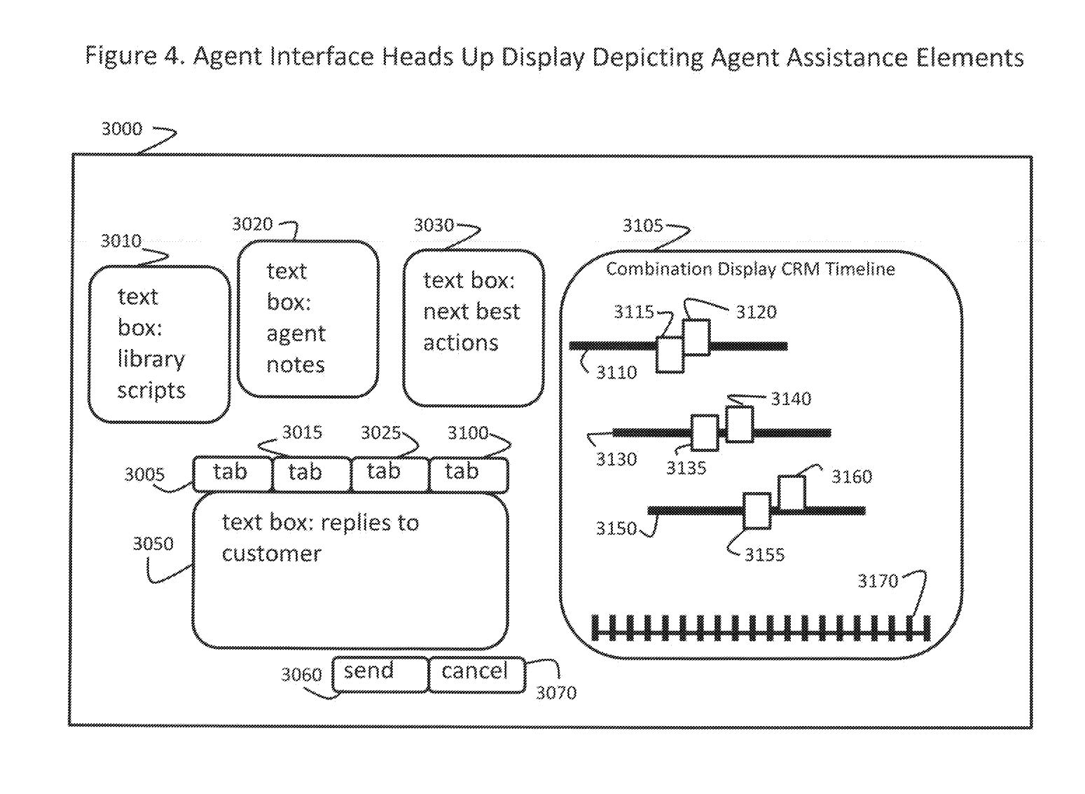

At step 1095, specific elements of the agent interface 305, 405 are populated. This will include suggested agent scripts that match with attributes of the social post content. Additionally this will include suggestions for next best action and author attributes including scores for relevancy, sentiment, and both social and enterprise influence. The display attributes for agent assistance are explained in further detail in FIGS. 3 and 4.

At step 1100, all data processed by the agent including replies, notes, changes to author attributes, etc. are finalized and tagged and time stamped. At step 1105, the finalized data is stored in the database 115. Alternately, at step 1110, the same or part of the data is stored in the CRM Customer Database 310,410.

With reference to FIG. 3, elements of the agent interface for agent assistance are shown in a display rendering 2000. Here, color-coded and number-scored semi-circles and circles are used to provide the agent with a heads-up display indicating author and customer attributes. Such color-coded displays may be rendered as other shapes or colors. In a preferred embodiment of the invention, such attributes are closely aligned with a customer avatar or photo so as to provide the agent with rapid recognition of the key values needed for customer service actions.

Accordingly, at 2005, a customer avatar or photograph is displayed. This may be associated with the social post or alternately may be stored as CRM Customer Data 310, 410. In a preferred embodiment of the invention, color-coded partial circles or full circles will surround the avatar or photo 2005.

At 2150, the closest circle around the proximity of the avatar or photo 2005, the color displayed may be red. Red can be chosen as the color representing the relevancy of the author or customer's post. For example, if the post is highly relevant, meaning the NLU Engine 125 rating of the content is high, the red color band 2150 may extend all the way around the customer avatar or photograph 2005. Alternately, if the post is not relevant, it may be marked as “spam” and have a lower score associated with a smaller coverage area of the color-coded circle 2150.

At 2250, the center circle around the proximity of the avatar or photo 2005, the color displayed may be blue. Blue can be chosen as the color representing the social influence of the author. For example, if the author is very influential on social networks, meaning the NLU Engine 125 rating of the author is high, the blue color band 2250 may extend all the way around the customer avatar or photograph 2005. Alternately, if the author is not a big social influencer, it may have a lower score associated with a smaller coverage area of the color-coded circle 2250.

At 2350, the furthermost circle around the proximity of the avatar or photo 2005, the color displayed may be green. Green can be chosen as the color representing the particular enterprise influence of the author. For example, if the author is a very important customer to the enterprise, meaning the CRM Customer Data 310, 410 rating of the author is high, the green color band 2350 may extend all the way around the customer avatar or photograph 2005. Alternately, if the author is not a big influential or important customer, it may have a lower score associated with a smaller coverage area of the color-coded circle 2350.

At 2100, a circle situated adjacent to the avatar or photo 2005, will have the same color code as the color band 2150 and will represent the same metric. In this case, the metric will be relevancy and the color will be red—matching the coding of the color band 2150. In the center of circle 2100 will be an absolute number, representing the exact score of the chosen metric.

At 2200, a circle situated adjacent to the avatar or photo 2005, will have the same color code as the color band 2250 and will represent the same metric. In this case, the metric will be social influence and the color will be blue—matching the coding of the color band 2250. In the center of circle 2200 will be an absolute number, representing the exact score of the chosen metric.

At 2300, a circle situated adjacent to the avatar or photo 2005, will have the same color code as the color band 2350 and will represent the same metric. In this case, the metric will be enterprise influence and the color will be green—matching the coding of the color band 2350. In the center of circle 2300 will be an absolute number, representing the exact score of the chosen metric.

At 2400, a circle situated adjacent to the avatar or photo 2005, will provide an additional metric that will be helpful in agent assistance. In this case, the metric will be author sentiment and the color will be green, blue or red so as to indicate happy, neutral, or unhappy, respectively. In the center of circle 2400 will be an absolute number, representing the exact score of the chosen metric.

With reference to FIG. 4, elements of the agent interface for agent assistance are shown in a display rendering 3000. Here, a series of tabs, buttons and text boxes provide the agent with a heads-up display that makes the disposition of transactions uniquely simple. Such displays may be rendered in a variety of shapes or colors. In a preferred embodiment of the invention, a series of tabs or buttons are situated together—each providing access to a pop-up text box or reference that provides agent assistance in a unique way.

At 3050, an editable text box, will provide the agent with a means to type a response to an author or customer. At 3060, a button may provide the ability to send the text to the author or customer. At 3070, a button may provide the ability to cancel the request and clear the editable text box 3050.

At 3005, a tab may be labeled “agent assist” and when pushed, provide a pop-up box with suggested library items based on the stored templates in database 115. In a preferred embodiment of the invention, such scripts will be matched using the NLU engine 125 based on word matching, phrase matching, or other intelligence that automatically searches for like issues and recommended responses based on the authors' posts. Such library suggestions may then be “double clicked” in order to populate the editable text box 3050.

At 3015, a tab may be labeled “agent notes” and when pushed, provide a pop-up box with an editable text space. In a preferred embodiment of the invention, the agent will use this text box to jot notes relative the disposition of the interaction. This data will be stored in the database 115 and subsequently be rendered for use by other agents or the same agent.

At 3025, a tab may be labeled “next best actions” and when pushed, provide a pop-up box with rules-based instructions to the agent based on the stored templates in database 115. In a preferred embodiment of the invention, such instructions will be governed by the rules engine 120 based on enterprise workflow and customer service protocols. Such instructions may then be “double clicked” in order to trigger a specific action, such as escalation to a supervisor or priority disposition.

At 3100, a tab may be labeled “CRM Timeline” and when pushed, provide a pop-up box as depicted in a combination display CRM timeline 3105. At a 3170, a graduated timeline using days, weeks, or months as intervals may be displayed and labeled appropriately at the bottom of the screen.

At 3110, 3130 and 3150, a series of horizontal bars are displayed. Each bar depicts a particular dialogue sequence with a particular author or customer. Particularly, the bars depict a specific dialog between the author or customer and one or more agents. These bars are color-coded to indicate the sentiment of the author. Accordingly, a color is assigned to each type of sentiment. For example, red may indicate angry, blue may indicate neutral, and green may indicate happy. These bars are situated above the graduated timeline 3170 to indicate the relative passage of time between the beginning of the dialog and the current state of the dialog. A practitioner in customer service design will appreciate the use of color-coding, and changes to color, over a timeline to indicate customer attributes, as standard interfaces require individual records to be opened and read to reveal attributes such as sentiment—none of which are color-coded.

At 3110, by clicking on the color-coded bar, a pop-up box appears to reveal the author's social posting. This pop-up box may also appear momentarily by simply hovering a mouse over the area. The mouse click provides a semi-persistent box that can be closed for detailed viewing. Additionally the pop-up box can contain time-stamp, disposition data, or other attributes tagged in the text.

At 3115, situated on top of the color-coded bar, but slightly South of center of the bar, a small color-coded box is depicted. This color-coded box indicates a subsequent communication from the customer or author based on the same topical reference as the original text from the customer or author. A practitioner of customer service will appreciate how the use of NLU technology may be used to gather customer dialog and arrange it in accordance with like issues. Such an arrangement makes viewing customer records by the agent much easier than reading through individual records that are not sorted nor color-coded.

At 3120, situated on top of the color-coded bar, but slightly North of center of the bar, another small color-coded box is depicted. This color-coded box indicates a response from an agent to the customer. Alternately, the box 3120 may contain a note taken by an agent dealing with the same dialog. A practitioner of customer service will appreciate how the use of agent notes and responses can be helpful to other agents who may subsequently have dealings with the customer. Traditionally, such notes and responses are only available embedded in individual records that have to be opened individually to view. In this timeline arrangement, all notes and responses are situated in the same view—providing only the movement of a mouse to reveal detailed text. The color-coding will allow the agent to determine what parts of the timeline need to be explored.

At 3130, another color-coded bar horizontal bar is displayed. The bar at 3130 may be colored differently than the bar at 3110, according to the sentiment or other appropriate attribute of the author or customer. Likewise, boxes 3135 and again 3140 may represent author comments and agent notes and replies, respectively. The theme of this part of the timeline is distinct from the first at 3110, because the topic may be different altogether from 3130. Accordingly, subsequent color-coded horizontal bars such as the one depicted at 3150 and its pop-up boxes at 3155 and again at 3160 provide details on yet another discrete dialogue. A practitioner of customer service will appreciate the color-coded juxtaposition of these various dialogues all in one heads-up display, and how an agent will save significant time in identifying themes, sentiment and other agents' actions all in one coordinated display.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A communications system for bridging social networks and customer contact centers, the system comprising:
a customer data access point disposable in communication with a social network to receive social data therefrom;
a natural language understanding (NLU) engine in communication with the customer data access point and configured to analyze the social data and identify actionable characteristics associated with the social data;
a rules engine in communication with the NLU engine and configured to match the identified actionable characteristics with a prescribed set of processing rules;
an application server in communication with the customer data access port, the NLU engine, and the rules engine and configured to execute the set of processing rules matched with the identified actionable characteristics; and
an enterprise data access point in communication with the application server and disposable in communication with a customer contact center to communicate with the customer contact center for executing the processing rules.

2. The communications system recited in claim 1, wherein the received social data includes a customer service request, the system further comprising:
a component database having stored prioritization levels associated with customer service request attributes;
the application server being configured to assign a prioritization label to the customer service request in response to a query of a component database.

3. The communication system recited in claim 1, further comprising an agent interface in communication with the enterprise data access point and configured to display customer information in accordance with a color coded scheme.

4. The communication system recited in claim 3, wherein the color coded scheme includes a central customer icon and at least one peripheral identifier disposed at least partially about the customer icon and associated with an attribute related to the social data author.

5. A method for bridging social networks and customer contact centers, the method comprising the steps of:
receiving social data from a social network;
analyzing the social data to identify actionable characteristics associated with the social data;
comparing the identified actionable attributes with a database of operational instructions matched with stored actionable attributes to identify operational instructions associated with the identified actionable attributes; and
executing the identified operational instructions which includes sending a communication to a customer contact center.

6. The method recited in claim 5 further comprising the step of storing the social data received from the social network.

7. The method recited in claim 5 wherein the analyzing step includes identifying at least one of routing, origination or tag information associated with the social data.

8. The method recited in claim 5 wherein the analyzing step includes processing the social data with a natural language understanding (NLU) engine to identify the actionable characteristics.

9. The method recited in claim 8 wherein the NLU engine categorizes the identified actionable characteristics into predefined categories, the categories being associated with operational instructions.

10. The method recited in claim 8 wherein the NLU engine analyzes the social data to determine a sentiment of the author of the social data, the identified sentiment being used to determine the operational instructions.

11. The method recited in claim 5 wherein the comparing step includes determining the routing instructions for the communication to be sent to the customer contact center.

12. The method recited in claim 5 wherein the comparing step includes assigning a prioritization to the operational instructions when the social data meets a prescribed prioritization threshold.

13. The method recited in claim 5 further comprising the step of matching the received social data with stored customer data.

14. The method recited in claim 13 wherein the matching step includes matching the received social data with buying history data associated with the author of the social data.

15. The method recited in claim 5 further comprising the step of generating a color coded display, wherein the colors depicted on the display are associated with attributes related to the social data author.

16. The method recited in claim 15 wherein the generating step includes generating a central customer icon and at least one peripheral identifier disposed at least partially about the periphery of the central customer icon, the at least one peripheral identifier being associated with an attribute related to the social data author.

17. The method recited in claim 5 further comprising the step of generating a color coded display associated with a customer relationship management timeline, depicting color coded correspondence between the author of the social data and the customer service center.

18. The method recited in claim 5 further comprising the step of generating an agent assistance template based upon information contained in the social data.

19. The method recited in claim 5 further comprising the step of assigning an author sentiment score associated with the social data.

20. The method recited in claim 5 further comprising the step of assigning an author influence score associated with the social data.
